(19) United States
(12) Patent Application Publication
(10) Pub. No.: US 2023/0027750 A1
(43) Pub. Date: Jan. 26, 2023

(54) VALVE FOR A SPRAY SYSTEM

(71) Applicant: VALEO SYSTEMES D'ESSUYAGE, La Verriere (FR)

(72) Inventor: Theophile JULLIEN, La Verriere (FR)

(73) Assignee: VALEO SYSTEMES D'ESSUYAGE, La Verriere (FR)

(21) Appl. No.: 17/788,067

(22) PCT Filed: Dec. 7, 2020
(86) PCT No.: PCT/EP2020/084958

§ 371 Date: Jun. 22, 2022

(30) Foreign Application Priority Data
Dec. 27, 2019 (FR) 1915698

(51) Int. Cl. B05B 15/14; B05B 1/30; F16K 39/02; F16K 31/06; B60S 1/48

(52) U.S. Cl. CPC B05B 15/14; B05B 1/3053; F16K 39/022; F16K 31/0655; B60S 1/481

(57) ABSTRACT

The present invention relates to a valve for a system for spraying a cleaning liquid, said valve comprising: —a valve body including a hydraulic cavity configured to be fluidically connected to a hydraulic channel of the spray system and intended to receive the cleaning liquid, —a plunger configured to be displaced in the hydraulic cavity between an open position, in which it allows the cleaning liquid to enter the hydraulic channel, and a closed position, in which it prevents the passage of the cleaning liquid through the hydraulic channel, —a compressible elastic element containing a gas disposed in the hydraulic cavity and configured to be compressed if the cleaning liquid in the valve freezes.

### TECHNICAL FIELD

The present invention relates to the field of systems for spraying cleaning liquid for motor vehicles, and in particular to the valves used in these systems.

### PRIOR ART

Motor vehicles all have a system for spraying cleaning liquid for maintaining the windshield of the vehicle itself and allowing the driver to look outwards in an optimum manner. Other optical devices, such as sensors, can also require such spray systems.

These systems generally comprise a reservoir for cleaning liquid, a pump and at least one valve which is configured to allow or prevent the passage of the cleaning liquid towards different spray endpieces or spray nozzles.

One of the problems with the hydraulic valves placed in the hydraulic circuit of the spray systems is the risk of malfunctioning of the valves, which is linked to the valves becoming frosted. Moreover, in the event of very low temperatures, the cleaning liquid present in the valve can freeze, thereby resulting in a deterioration of the valve due to the water expanding as it freezes, causing the system for spraying cleaning liquid to fail.

In order to avoid such a deterioration of the valves in the event of freezing, it is therefore necessary to find a solution that makes it possible to protect the electromagnetic valves in the systems for spraying cleaning liquid for motor vehicles in the event of freezing.

### SUMMARY OF THE INVENTION

To that end, what is proposed is a valve for a system for spraying a cleaning liquid, said valve comprising:
a valve body including a hydraulic cavity configured to be fluidically connected to a hydraulic channel of the spray system and intended to receive the cleaning liquid,
a plunger configured to be displaced in the hydraulic cavity between an open position, in which it allows the cleaning liquid to enter the hydraulic channel, and a closed position, in which it prevents the cleaning liquid from passing through the hydraulic channel, the valve also comprising a compressible elastic element containing a gas disposed in the hydraulic cavity and configured to be compressed if the cleaning liquid in the valve freezes.

According to one embodiment, the compressible elastic element containing a gas is a closed-cell foam.

The closed-cell foam is made from ethylene-propylene-diene monomer “EPDM”.

According to one embodiment, the volume of foam corresponds to at least 10% of the volume of the hydraulic cavity, in particular 10% of the volume of the hydraulic cavity.

According to one embodiment, the valve is an electromagnetic valve also comprising:
a coil (13) configured to displace the plunger (7) from the closed position to the open position.

According to one embodiment, the hydraulic cavity comprises a first portion, surrounded by the coil, and a second portion separate from the first portion, and wherein the compressible elastic element containing a gas is disposed in the second portion of the hydraulic cavity.

According to one embodiment, the compressible elastic element containing the gas is fixed on the plunger.

According to one embodiment, the plunger comprises a first portion configured to come into contact with the valve body in the closed position, and wherein the compressible elastic element containing the gas is fixed on the plunger at a second portion separate from the first portion.

The present invention also relates to a system for spraying a cleaning liquid, comprising a liquid reservoir, a pump, at least one endpiece for spraying cleaning liquid, and at least one valve (1) according to one of the embodiments above.

### BRIEF DESCRIPTION OF THE DRAWINGS

Further features and advantages of the invention will become more clearly apparent upon reading the following description, which is given by way of illustrative and non-limiting example, and the appended drawings, in which:

FIG. 1 shows a schematic representation of a system for spraying cleaning liquid;

FIG. 2 shows a schematic view in section of a solenoid valve in the closed state according to one embodiment of the present invention;

FIG. 3 shows a schematic perspective view of a solenoid valve;

FIG. 4 shows a schematic view in section of a solenoid valve in the open state according to one embodiment of the present invention.

In these figures, identical elements have the same reference signs.

### DETAILED DESCRIPTION

The following embodiments are examples. Although the description refers to one or more embodiments, this does not necessarily mean that each reference relates to the same embodiment, or that the features apply only to a single embodiment. Individual features of various embodiments may also be combined or interchanged in order to create other embodiments.

Implementations and embodiments of the invention relate to a valve for a system for spraying liquid.

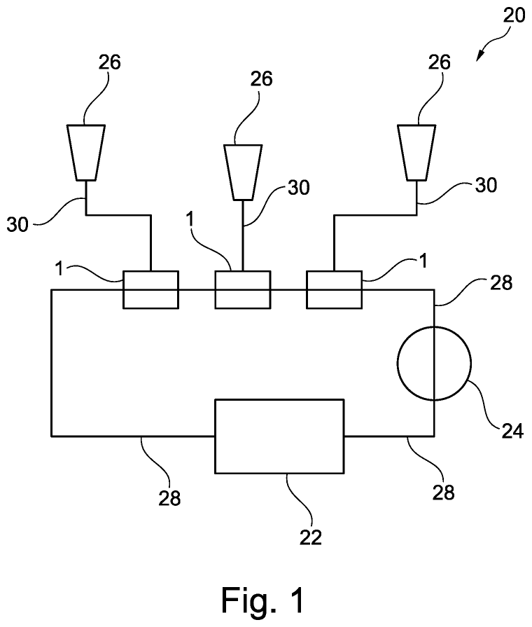

FIG. 1 shows an exemplary embodiment of a spray system 20 comprising a liquid reservoir 22, a pump 24, three spray endpieces 26 for spraying cleaning liquid which are configured for example to spray a cleaning liquid over the windshield or over optical elements of a motor vehicle. The spray system 20 also comprises three valves 1 for controlling the distribution of the cleaning liquid to the spray endpieces 26. The valves 1 are connected to the reservoir 22 by supply hoses 28 and the spray endpieces 26 are connected to the valves 1 by distribution hoses 30.

The valves 1 are for example electromagnetic valves comprising a coil which, when it is supplied with power, makes it possible to control the displacement of a plunger as described in the remainder of the description. However, the invention is not limited to electromagnetic valves and can also be applied to other valve types.

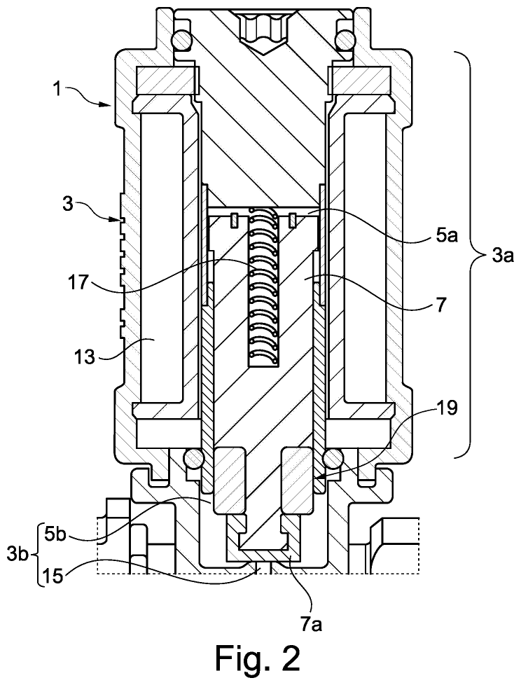

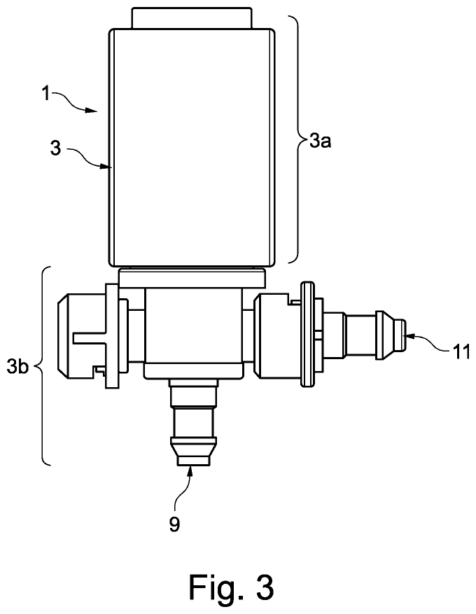

FIG. 2 shows a view in section of the electromagnetic valve 1 showing the internal elements of the electromagnetic valve 1, and FIG. 3 shows a perspective view of an electromagnetic valve 1. The electromagnetic valve 1 is configured to be disposed in a spray system 20 for spraying a cleaning liquid, as is shown in FIG. 1.

The electromagnetic valve 1 comprises a valve body 3 including a hydraulic cavity 5 in which a plunger 7 is positioned. The valve body 3 comprises a first part 3a comprising a coil 13 disposed around a first portion 5a of the hydraulic cavity 5 and a second part 3b in which are formed a first orifice 9, corresponding to an inlet orifice for the fluid, and a second orifice 11, corresponding to an outlet orifice for the fluid, and including a second portion 5b of the hydraulic cavity 5.

The first orifice 9 is configured to be attached to a supply hose 28 for the fluid, for example a cleaning or washing liquid. The supply hose 28 is for example connected to a reservoir 22 for cleaning liquid via a supply pump 24 for supplying the cleaning liquid.

The second orifice 11 is configured to be attached to a spray endpiece 26 via a distribution hose 30.

The electromagnetic valve 1 also comprises a hydraulic channel 15 connecting the first orifice 9 and the second orifice 11, said hydraulic channel 15 being in a fluidic relationship with the hydraulic cavity 5 in which the plunger 7 is disposed (the hydraulic channel 15 therefore locally coincides with the second portion 5b of the hydraulic cavity 5). The hydraulic channel 15 is configured to be continued on either side of the electromagnetic valve 1, in particular via the hoses 28, 30, so as to transfer the cleaning liquid from the reservoir 22 to a spray endpiece 26.

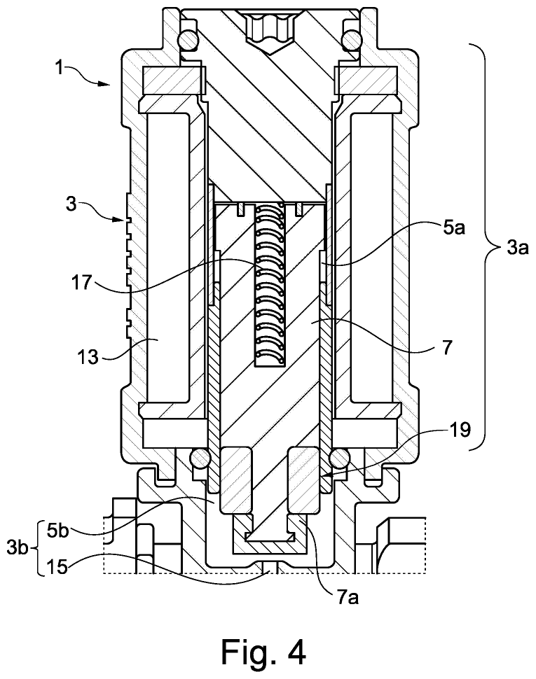

The plunger 7 is configured to be displaced between an open position (shown in FIG. 4), in which it allows the cleaning liquid to pass between the supply hose 28 and the distribution hose 30, and a closed position (shown in FIG. 2), in which it prevents the passage of the cleaning liquid between the supply hose 28 and the distribution hose 30.

The plunger 7 comprises a first portion 7a, corresponding to a flexible end in the present case, for example an elastomer or rubber end, so as to allow good leaktightness in the closed position, the first portion 7a coming into contact with a wall of the valve body 3 in the closed position so as to prevent the passage of the cleaning liquid through the hydraulic channel 15, that is to say between the first orifice 9 and the second orifice 11. The plunger 7 is displaced from the closed position to the open position via supplying the coil 13 with power (for example above a predetermined voltage threshold). An elastic stressing element 17, for example a helical spring, may be disposed between the valve body 3 (or an element fixed with respect to the valve body 3) and the plunger 7 and configured to place the plunger 7 under stress in the closed position when power is not supplied to the coil 13 (or if the power supplied is lower than the predetermined voltage threshold).

Moreover, in order to avoid damage to the valve body 3 when the cleaning liquid inside the hydraulic cavity 5 freezes, for example when the outside temperatures are below 0° C., the electromagnetic valve 1 also comprises a compressible elastic element 19 containing a gas, for example air, and disposed in the hydraulic cavity 5. This compressible elastic element 19 is for example a closed-cell foam and acts like a compressible cushion.

The compressible elastic element 19 is for example fixed on the wall of the hydraulic cavity 5 or on the plunger 7. The compressible elastic element 19 is fixed for example by adhesive bonding. The compressible elastic element 19 occupies for example at least 10% of the volume of the hydraulic cavity 5 (when it is not compressed), this corresponding to the additional volume taken up by the ice in relation to the water. This volume may also be equal to 10% of the volume of the cavity or even slightly less, depending on the cleaning liquid used.

In the case of an electromagnetic valve 1, the compressible elastic element 19 is preferably spaced apart from the coil 13, that is to say is located outside the first portion 5a of the hydraulic cavity 5 surrounded by the coil 13 so as to avoid any disruption to the electromagnetic operation of the valve 1.

The compressible elastic element 19 is preferably positioned remotely from the interface zones between parts that are movable with respect to one another so as to avoid any deterioration of the compressible elastic element 19 by mechanical friction caused by contact with the various parts. When the compressible elastic element is fixed on the plunger 7, the compressible elastic element 19 is for example fixed on a second portion separate from the first portion 7a and in particular spaced apart from that part of the first portion 7a that comes into contact with a wall of the valve body 3. The closed-cell foam of the compressible elastic element 19 is for example made of ethylene-propylene-diene monomer, more commonly referred to as EPDM.

In this way, if the cleaning liquid in the valve body 3 freezes, the ice prioritizes compression of the compressible elastic element 19, which is more flexible than the walls of the valve body 3 or of the plunger 7, thereby allowing the latter to be protected. The present invention also relates to a spray system 20 for spraying a cleaning liquid, comprising a liquid reservoir 22, a pump 24, at least one spray endpiece 26 for spraying cleaning liquid, and at least one valve 1 as described above.

What is claimed is:

1. Valve for a system for spraying a cleaning liquid, said valve comprising:
a valve body including a hydraulic cavity configured to be fluidically connected to a hydraulic channel of the spray system and intended to receive the cleaning liquid,
a plunger configured to be displaced in the hydraulic cavity between an open position, in which it allows the cleaning liquid to enter the hydraulic channel, and a closed position, in which it prevents the cleaning liquid from passing through the hydraulic channel,
characterized in that the valve also comprises a compressible elastic element containing a gas disposed in the hydraulic cavity and configured to be compressed if the cleaning liquid in the valve freezes.

2. Valve according to claim 1, wherein the compressible elastic element containing a gas is a closed-cell foam.

3. Valve according to claim 1, wherein the closed-cell foam is made from ethylene-propylene-diene monomer “EPDM”.

4. Valve according to claim 1, wherein the volume of foam corresponds to at least 10% of the volume of the hydraulic cavity, in particular 10% of the volume of the hydraulic cavity.

5. Valve according to claim 1, which is an electromagnetic valve also comprising:
a coil configured to displace the plunger from the closed position to the open position.

6. Valve according to claim 5, wherein the hydraulic cavity comprises a first portion, surrounded by the coil, and a second portion separate from the first portion, and wherein the compressible elastic element containing a gas is disposed in the second portion of the hydraulic cavity.

7. Valve according to claim 1, wherein the compressible elastic element containing the gas is fixed on the plunger.

8. Valve according to claim 7, wherein the plunger comprises a first portion configured to come into contact with the valve body in the closed position, and wherein the compressible elastic element containing the gas is fixed on the plunger at a second portion separate from the first portion.

9. System for spraying a cleaning liquid, comprising a liquid reservoir, a pump, at least one endpiece for spraying cleaning liquid, and at least one valve according to claim 1.
